(19) United States
(12) Patent Application Publication
(10) Pub. No.: US 2025/0170831 A1
(43) Pub. Date: May 29, 2025

(54) COLOR PRINTER AND SOLVING METHOD

(71) Applicant: SEIKO EPSON CORPORATION, Tokyo (JP)

(72) Inventor: Kazushige TAYUKI, Matsumoto (JP)

(21) Appl. No.: 18/959,753

(22) Filed: Nov. 26, 2024

(30) Foreign Application Priority Data
Nov. 28, 2023 (JP) 2023-200475

(51) Int. Cl. B41J 2/21; B41J 2/51

(52) U.S. Cl. CPC B41J 2/2142; B41J 2/512

(57) ABSTRACT

A color printer includes: a printing unit configured to print check patterns and explanatory texts for the check patterns; and an interface configured to accept a result of checking the check patterns from a user, and the printing unit prints the explanatory texts by using multiple colors and/or multiple nozzle rows.

The present application is based on, and claims priority from JP Application Serial Number 2023-200475, filed Nov. 28, 2023, the disclosure of which is hereby incorporated by reference herein in its entirety.

### BACKGROUND

### 1. Technical Field

The present disclosure relates to a color printer and a solving method.

### 2. Related Art

It has been known that a user causes a printer to print check patterns, uses the result of the printing to check the state of the printer, and adjusts the printer. JP-A-2002-082511 describes a printing color balance adjustment pattern containing a halftone gray (composite black) image in which yellow, magenta, and cyan images are printed with the images superimposed on each other, and performing color balance adjustment by using the result of the printing.

JP-A-2002-082511 is an example of the related art.

In general, when check patterns are printed, explanatory texts (which may each instead be single character such as number or alphabetical letter) are also printed to describe what the printed patterns are used to check. However, abnormality in the mechanism that prints the explanatory texts causes a problem of illegible explanatory texts for the check patterns.

### SUMMARY

A color printer for solving the problem described above includes a printing unit configured to print check patterns and explanatory texts for the check patterns; and an interface configured to accept a result of checking the check patterns from a user, and the printing unit prints the explanatory texts by using multiple colors and/or multiple nozzle rows.

A method for solving the problem described above includes printing check patterns; printing explanatory texts for the check patterns by using multiple colors and/or multiple nozzle rows; accepting a result of checking the check patterns from a user; and solving abnormality in accordance with the result of the checking.

### BRIEF DESCRIPTION OF THE DRAWINGS

FIG. 1 is a block diagram of a printer.

FIG. 2 shows an example of nozzle rows.

FIG. 3 shows an example of a check image as Comparative Example.

FIG. 4 illustrates the configuration of the check image.

FIG. 5 shows an example of the check image printed when black nozzles clog up.

FIG. 6 shows an example of the check image according to the present embodiment.

FIG. 7 shows an example of the check image printed when the black nozzles clog up.

FIG. 8 shows an example of the check image according to the present embodiment.

FIG. 9 shows a flowchart of a nozzle check process.

FIG. 10 shows an example of the check image according to another embodiment.

FIG. 11 shows an example of the nozzle row according to the other embodiment.

FIG. 12 shows an example of the check image according to another embodiment.

### DESCRIPTION OF EMBODIMENTS

Embodiments of the present disclosure will be described below in the following order:
(1) Configuration of printer
(2) Printing check patterns
(3) Other embodiments

### (1) Configuration of Printer

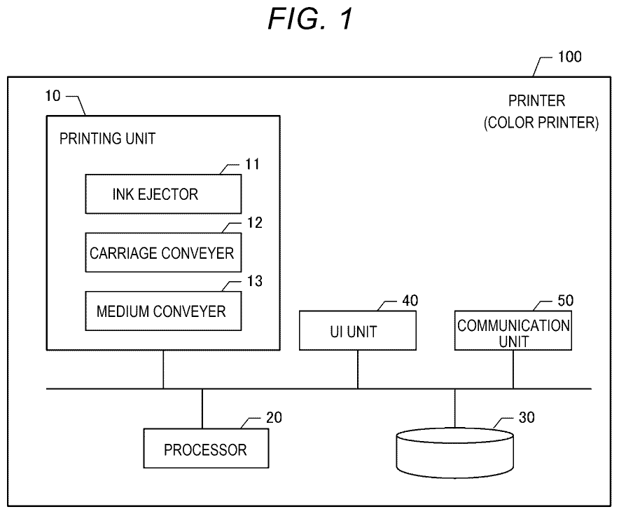

FIG. 1 is a block diagram showing the

configuration of a printer 100 as a color printer according to an embodiment of the present disclosure. In the present embodiment, the printer 100 is a serial inkjet printer that ejects ink while causing a carriage in which a printhead is incorporated to make a reciprocating motion. The printer 100 includes a printing unit 10, a processor 20, a nonvolatile memory 30, a UI unit 40, and a communication unit 50.

The printing unit 10 includes an ink ejector 11,

a carriage conveyer 12, a medium conveyer 13, and a maintenance section (not shown). The carriage conveyer 12 includes a motor, a motor driver, and a carriage rail, and causes the carriage to make a reciprocating motion along the carriage rail. The direction in which the carriage is moved is referred to as a primary scanning direction. The medium conveyer 13 includes a conveying roller and a roller driver, and conveys a print medium. The direction in which the print medium is conveyed is a direction perpendicular to the primary scanning direction, and is referred to as a secondary scanning direction.

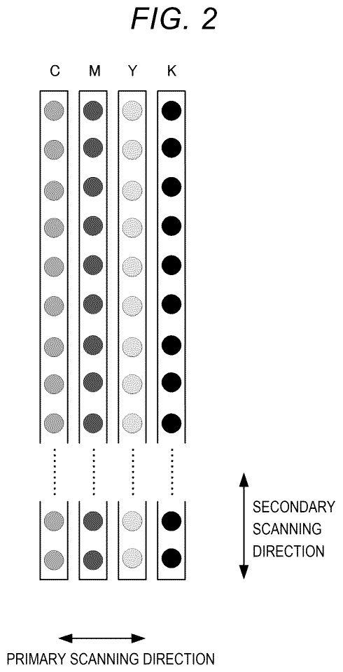

The ink ejector 11 includes a printhead and a printhead driver. The printhead is incorporated in the carriage. A nozzle plate of the printhead is provided with nozzles via which inks supplied from ink cartridges or ink tanks are ejected. In the present embodiment, nozzle rows corresponding to four types of inks, cyan (C), magenta (M), yellow (Y), and black (K) are provided. The nozzle rows, which each include multiple nozzles via which ink of the same color is ejected, are disposed in parallel to the secondary scanning direction, as shown in FIG. 2. The number of ink colors, the number of nozzle rows, the arrangement of the nozzle rows, and the types of the ink colors described above are, of course, merely examples, and are not limited to those in the aspect of the present embodiment. For example, the positions of the nozzles of adjacent nozzle rows in the secondary scanning direction may differ from each other. The printhead driver drives a piezoelectric device provided in correspondence with each of the nozzles to eject ink via the nozzle. In the present embodiment, the printhead driver allows the printhead to eject ink in the form of large dots or small dots. The printing unit 10 can put ink at any position on a print medium by moving the medium in the secondary scanning direction and causing the printhead to eject ink at different positions in the primary scanning direction.

The maintenance section includes a wiping mechanism and a capping mechanism. The wiping mechanism includes a wiper that wipes the nozzle plate of the printhead to remove deposits such as ink, and a driving part that drives the wiper. The capping mechanism includes a box-shaped cap that seals the nozzle plate of the printhead and a driving part that moves the cap relative to the nozzle plate. The capping mechanism sucks the ink or flushes the nozzle plate with the nozzles blocked by the cap.

The processor 20 includes a CPU, a ROM, and a RAM, and can control each of the units of the printer 100 by executing programs recorded in the ROM and the nonvolatile memory 30. Note that the processor 20 may be configured with a single chip, may be configured with multiple chips, or may be configured as an SoC into which various functional blocks that allow the printer 100 to perform. Instead, for example, the CPU may be replaced with an ASIC, or the CPU and an ASIC may cooperatively operate.

The programs executed by the processor 20, setting data, image data, and the like are recorded in the nonvolatile memory 30. The setting data is data representing parameters used when the printer 100 carries out various processes. The image data contains data representing a check image containing nozzle check patterns and explanatory texts.

The UI unit 40 is an apparatus that accepts a user's input and outputs various types of information to the user. The UI unit 40 includes, for example, an operation section including a touch panel display and mechanical keys. The touch panel display includes a display panel that displays various types of information, and a touch operation detector superimposed on the display panel. The UI unit 40 causes the display panel of the UI unit 40 to display various kinds of information under the control of the processor 20. In the present embodiment, the processor 20 can control the UI unit 40 to accept the user's input to a software key provided at the touch panel display or a mechanical key provided at the UI unit 40. The processor 20 carries out a process corresponding to the input content.

The communication unit 50 includes various removable memories attached to the printer 100, and an interface circuit that communicates with a device connected to the printer 100 via wiring or wirelessly. The processor 20 can acquire a file recorded as a printing target in the device connected via the communication unit 50.

The processor 20 can accept input of an instruction to print the nozzle check patterns or input of the result of checking the printed nozzle check patterns via the UI unit 40, or can accept the input from the device connected via the communication unit 50. The UI unit 40 and the communication unit 50 can therefore function as an interface that accepts the result of checking the check patterns from the user.

### (2) Printing Check Patterns

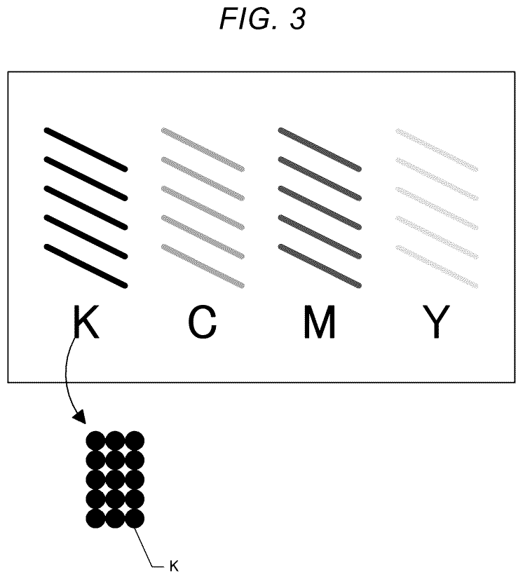

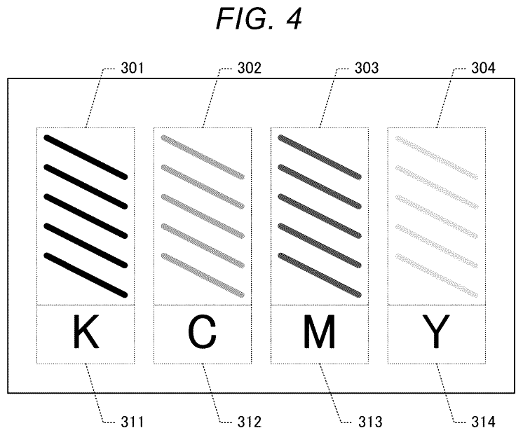

FIG. 3 shows the check image containing the nozzle check patterns used to evaluate whether each of the color inks is ejected via the nozzles appropriately. FIG. 4 illustrates the configuration of the check image shown in FIG. 3. The check image contains patterns 301, 302, 303, and 304, in which dot groups for checking the ejection state are printed on an ink color basis, and explanatory texts 311, 312, 313, and 314, which are disposed in the vicinity of the respective patterns and indicate the ink colors used to print the patterns, as shown in FIG. 4. The explanatory texts may each be one letter as shown in FIGS. 3 and 4. In the present embodiment, the explanatory text 311, which is [K], is printed in the vicinity of the black ink pattern 301, the explanatory text 312, which is [C], is printed in the vicinity of the cyan ink pattern 302, the explanatory text 313, which is [M], is printed in the vicinity of the magenta ink pattern 303, and the explanatory text 314, which is [Y], is printed in the vicinity of the yellow ink pattern 304.

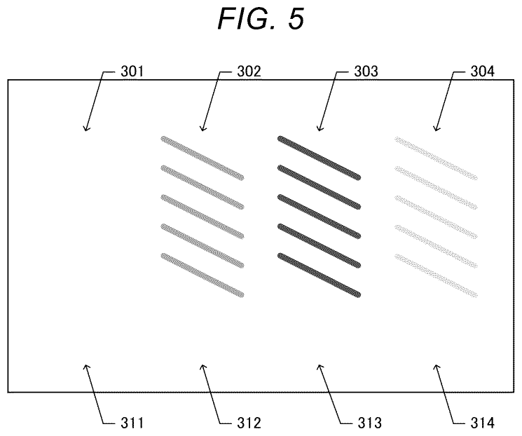

In related art, the explanatory texts 311, 312, 313, and 314 are each generally printed with black ink in the form of a black letter. However, when the printer is not used for a long period of time, the nozzles could clog up. When the check image shown in FIG. 3 is printed in a state in which all the nozzles for the black ink clog up so that the black ink is not ejected via any of the nozzles, the pattern 301 configured with the black ink dot groups and all the explanatory texts 311, 312, 313, and 314 are not printed, and the check image shown in FIG. 5 is printed. Such a check image may give the user an impression as if no black ink has been loaded in the printer 100. Such a check image may instead mislead the user into believing that the specifications do not allow the black ink to be used to print the check image. As a result, there is a possibility of failure not to allow the user to be aware that the nozzles for the black ink have clogged up and should be cleaned.

Therefore, in the present embodiment, the printing unit 10 prints the explanatory texts in multiple colors. Specifically, in the present embodiment, the printing unit 10 prints the explanatory texts with a mixture of all the ink colors usable in the printer 100.

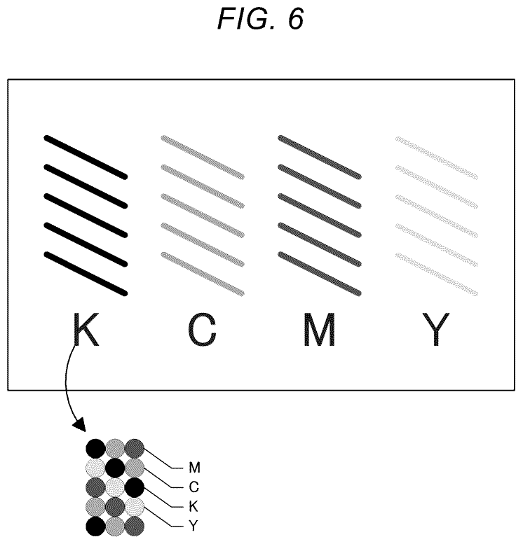

FIG. 6 shows an example in which large black dots, large cyan dots, large magenta dots, and large yellow dots are ejected in the same proportion per unit area to print the explanatory texts 311, 312, 313, and 314. The color dots are not necessarily ejected in the same proportion, but it is desirable when no nozzle clogs up to employ a proportion that allows the explanatory texts to be expressed in black or dark gray. Causing the amounts of CMYK inks per unit area to be ejected in the same proportion or substantially the same proportion allows the explanatory texts to be printed in black or dark gray when no nozzle clogs up. The explanatory texts, which are printed with black ink in many cases in related art, can be printed in black or gray when there is no abnormality with the nozzles, so that the possibility of causing the user to feel something is wrong can be reduced.

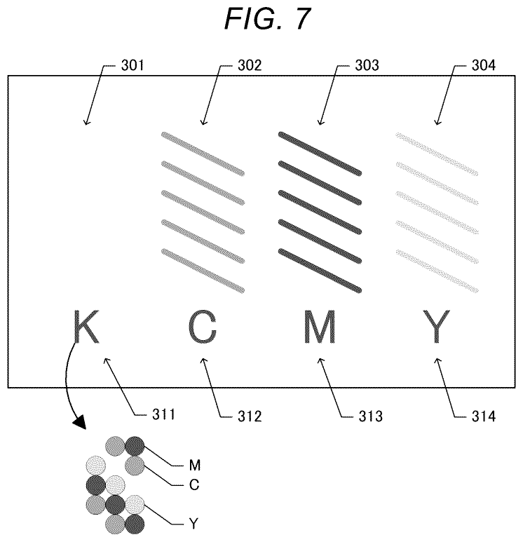

When the explanatory texts are all printed with a mixture of the all the ink colors, as shown in FIG. 6, and if all the nozzles for the black ink clog up, the black pattern 301 is not printed as shown in FIG. 7, but the letters [K], [C], [M], and [Y], which are the explanatory texts 311, 312, 313, and 314, are printed legibly with the large cyan dot, large magenta dot, and large yellow dot inks other than the large black dot ink although the printed letters are light in color as compared with the case where the black nozzles do not clog up. Printing the explanatory texts in all the colors and/or a mixture of the colors from all the nozzle rows can increase the possibility of printing legible explanatory texts even when any of the color printing mechanisms or any of the nozzle rows operates abnormally.

The patterns 302, 303, and 304 are printed in the vicinity of the explanatory texts 312, 313, and 314, respectively, but no pattern is printed in the vicinity of the explanatory text 311, which is [K]. There is therefore an increased possibility of the user being aware of the presence of a pattern that should have been printed in correspondence with the explanatory text 311. There is also an increased possibility of the user being aware that the nozzles for the black ink fail in ejection and should be cleaned. Furthermore, even when the nozzles for any of the colors other than the black ink clog up, there is an increased possibility of printing a legible explanatory text in the form of dots of the ink colors from the non-clogging nozzles, and as a result, there is an increased possibility of the user being aware of the presence of the ink color causing an abnormal pattern.

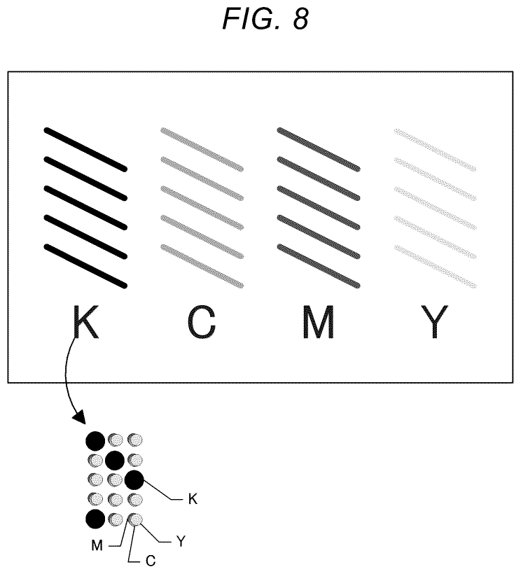

Note that the explanatory texts 311, 312, 313, and 314 may be configured with large black dots and small cyan, magenta, and yellow dots, as shown in FIG. 8, and in this case as well, there is an increased possibility of printing legible explanatory texts even when any of the nozzles clogs up.

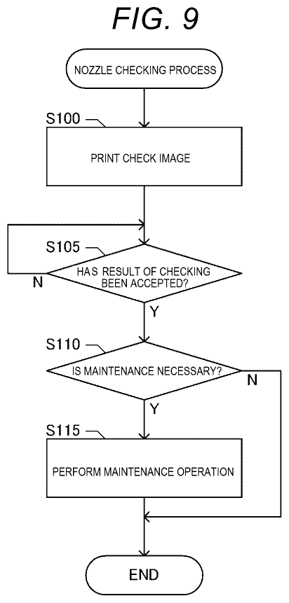

A nozzle check process will next be described with reference to FIG. 9. The nozzle check process is carried out when an instruction to print the check image for the nozzle check is accepted from the user. When the nozzle check process is initiated, the processor 20 prints the check image (step S100). The check image in the present embodiment contains the patterns 301, 302, 303, and 304 and the explanatory texts 311, 312, 313, and 314, as shown in FIG. 4. In the present embodiment, the processor 20 prints the patterns in a one-pass operation and prints the explanatory texts in a multiple-pass operation. That is, the processor 20 causes the printhead to print a region (band) of the patterns 301, 302, 303, and 304 that has a predetermined width in the secondary scanning direction when the carriage makes the first half of the reciprocating motion. The printing operation described above can shorten the printing period required to print the pattern portions. Furthermore, printing the patterns in the first half of the reciprocating motion allows printing of patterns that are not affected by the accuracy of the medium conveyance. When the explanatory texts 311, 312, 313, and 314 are printed, the processor 20 performs the printing by both the first half of the reciprocating motion and the second half of the reciprocating motion of the carriage while causing the medium conveyer 13 to convey the medium by a predetermined amount. The printing operation described above allows improvement in the quality of the printed explanatory texts, and an increase in the possibility of printing legible explanatory texts even when any of the nozzles clog up.

Subsequently, the processor 20 waits until the processor 20 accepts the result of the checking (step S105). That is, the processor 20 waits until the user having checked the printed check image inputs the result of the checking of the check image.

When the processor 20 determines in step S105 that the processor 20 accepts the result of the checking, the processor 20 evaluates whether the accepted checking result is a result indicating that maintenance is necessary (step S110). When the processor 20 determines in step S110 that the checking result indicates that maintenance is necessary, the processor 20 performs a maintenance operation (step S115). That is, the processor 20 causes the maintenance section to perform wiping, flushing, and suction of ink.

When the processor 20 does not determine in step S110 that the checking result indicates that maintenance is necessary, the processor 20 does not perform the maintenance operation but terminates the nozzle checking process. When the user inputs the instruction to print the nozzle check patterns again after the maintenance operation in step S115 is performed, the nozzle check process in FIG. 9 is carried out again.

As described above, according to the present embodiment, when the check image used to check the nozzles of a serial inkjet printer is printed, the explanatory texts in the check image are printed by using inks of multiple colors, which can increase the possibility of printing legible explanatory texts even when any of the printing mechanisms for the multiple ink colors operates abnormally. As a result, the possibility of allowing the user to adequately check the printed check image can be increased.

### (3) Other Embodiments

The embodiment described above is an example for implementing the present disclosure, and a variety of other embodiments can be employed. For example, the printer may be configured to print a check image acquired from a device connected to the printer via the communication section. The patterns contained in the check image are not limited to patterns for checking clogging of any of the nozzles, and may contain patterns for checking various items. For example, the patterns may contain various patterns for abnormality detection, such as a pattern for checking the state of the medium conveyance (presence or absence of banding), and a pattern for checking deviation of the ink landing position in the primary scanning direction. When abnormality is detected based on the result of the printed patterns, the printer carries out the process of solving the detected abnormality. The explanatory texts may be configured with letters, symbols, sentences, or the like indicating what the various patterns are used to check. Furthermore, the arrangement of the patterns and the explanatory texts is not limited to that in the embodiment described above, and the patterns and the explanatory texts may be arranged in various manners.

The printing unit may be configured to print the explanatory texts with at least two types of inks, for example, a composite black ink. That is, the explanatory texts may be printed in black or gray without using black ink. The configuration described above allows the explanatory texts to be printed in black or gray, which is an achromatic color, as is customary when none of the printing mechanisms operates abnormally, and possibility of causing the user to feel something is wrong to be reduced as compared with the case where the explanatory texts are printed in a chromatic color.

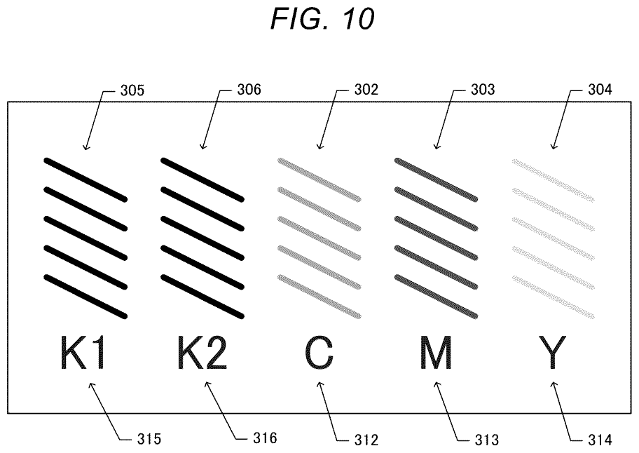

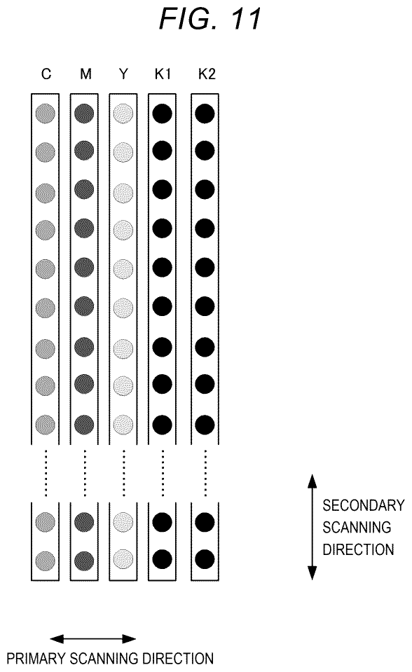

In the embodiment described above, the number of nozzle rows for each ink color is one, but the number of nozzle rows for each ink color may be two or more. When there are two nozzle rows per ink color, the printing unit may be configured to print the explanatory texts in all the colors and/or a mixture of the color inks from all the nozzle rows. For example, FIG. 10 shows an example of the check image in a case where there is one nozzle row for each of the cyan, magenta, and yellow inks and there are two nozzle rows, K1 and K2, for the black ink, as shown in FIG. 11. In this example, the explanatory texts 315, 316, 312, 313, and 314 may be printed with all the ink colors (CMYK) including C, M, Y, and K1, or with all the ink colors including C, M, Y, and K2. The explanatory texts 315, 316, 312, 313, and 314 may instead be printed by using all the ink colors C, M, Y, K1, and K2 and all the nozzle rows. Printing the explanatory texts in all the colors and/or a mixture of the colors from all the nozzle rows can increase the possibility of printing legible explanatory texts even when any of the color printing mechanisms or any of the nozzle rows operates abnormally. Note that the explanatory texts may be printed by using the two black nozzle rows, K1 and K2.

In addition, the explanatory texts may each be printed by employing a configuration in which the printing is performed with a mixture of colors different from the color of the pattern disposed in the vicinity of the explanatory text. An example of the configuration described above will be described with reference to FIG. 4. For example, the explanatory text 312 for the cyan pattern 302 may be printed with a mixture of K, M, and Y, which are the ink colors other than cyan, the explanatory text 313 for the magenta pattern 303 may be printed with a mixture of K, C, and Y, which are the ink colors other than magenta, the explanatory text 314 for the yellow pattern 304 may be printed with a mixture of K, C, and M, which are the ink colors other than yellow, and the explanatory text 311 for the black pattern 301 may be printed with a mixture of C, M, and Y, which are the ink colors other than black. Therefore, even when the printing mechanism for the color of the pattern in the vicinity of any of the explanatory texts operates abnormally, printing the explanatory text with a mixture of the colors different from the color of the pattern can increase the possibility of printing a legible explanatory text without being affected by the abnormality of the printing mechanism for the color.

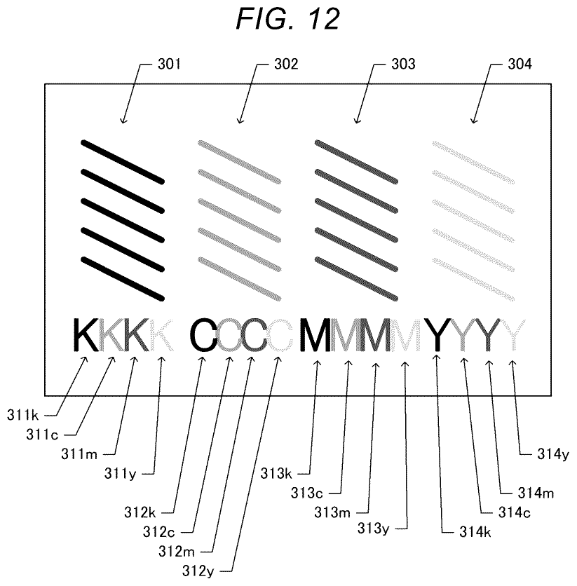

An explanatory text may be printed with a mixture of multiple colors or colors from multiple nozzle rows, and an explanatory text printed in a single color or with a single nozzle row may instead be printed with the ink color or nozzle rows arranged side by side. FIG. 12 shows an example in which four-color explanatory texts printed with respective K, C, M, and Y single-color inks are printed in the vicinity of the K, C, M, and Y patterns 301, 302, 303, and 304. For example, explanatory texts 311k, 311c, 311m, and 311y are printed in the vicinity of the black pattern 301. The explanatory texts 311k, 311c, 311m, and 311y are each printed in a single color, the black ink, cyan ink, magenta ink, and yellow ink, respectively. Note that when two or more nozzle rows are provided for a single ink color, an explanatory text may, of course, be printed on a nozzle row basis. Printing multiple explanatory texts by using multiple colors and/or multiple nozzle rows (printing multiple explanatory texts having same content) as described above allows an increase in the possibility of printing legible explanatory texts to be printed even when any of the printing mechanisms or the multiple nozzle rows for the multiple colors operates abnormally.

The aforementioned embodiment has been described with reference to the case where a serial inkjet printer prints patterns in one-pass operation and explanatory texts multiple-pass operation, but not necessarily. How to perform the printing may be determined in accordance, for example, with the size and shape of the patterns, the arrangement of the patterns, the carriage movement speed, and the medium conveyance speed.

Furthermore, the present disclosure is applicable to a printer other than a serial inkjet printer using piezoelectric devices. For example, the present disclosure is applicable to a thermal inkjet printer, an electrophotographic printer, or the like. Also in an electrophotographic printer, at the time of printing patterns, printing each of the explanatory texts for the patterns using multiple colors can increase the possibility of printing legible explanatory texts even when any of the printing mechanisms for the multiple colors operates abnormally.

The present disclosure is also applicable to a program or a method executed by a computer. For example, the present disclosure also holds as a disclosure of a solving method including printing check patterns, printing explanatory texts for the check patterns by using multiple colors and/or multiple nozzle rows, accepting the result of checking of the check patterns from the user, and solving abnormality in accordance with the result of the checking. Furthermore, the system, the program, and the method described above may be implemented as a stand-alone apparatus in some cases, or may be implemented by using parts provided in multiple apparatuses in other cases, and include various aspects. Further, the present disclosure may be changed as appropriate, such as partially changes in software or partially changes in hardware. Moreover, the present disclosure may be realized as a recording medium storing a program that controls the system. Obviously, the recording medium storing the program may be a magnetic recording medium or may be a semiconductor memory, and any recording medium to be developed in the future can be similarly employed.

What is claimed is:

1. A color printer comprising:
a printing unit configured to print check patterns and explanatory texts for the check patterns; and
an interface configured to accept a result of checking the check patterns from a user,
wherein the printing unit prints the explanatory texts by using multiple colors and/or multiple nozzle rows.

2. The color printer according to claim 1, wherein
the printing unit prints the explanatory texts in composite black.

3. The color printer according to claim 1, wherein
the printing unit prints the explanatory texts in all the colors and/or a mixture of the colors from all the nozzle rows.

4. The color printer according to claim 1, wherein
the check patterns are nozzle check patterns.

5. The color printer according to claim 4, wherein
the explanatory texts are each a text indicating a color or a nozzle row for the pattern disposed in the vicinity of the explanatory text.

6. The color printer according to claim 5, wherein
the explanatory texts are each printed in a mixture of the colors that differs from a color of the pattern disposed in the vicinity of the explanatory text.

7. The color printer according to claim 1, wherein
the color printer is a serial inkjet printer.

8. The color printer according to claim 7, wherein
the explanatory texts are printed in a multiple-pass operation.

9. A solving method comprising:
printing check patterns;
printing explanatory texts for the check patterns by using multiple colors and/or multiple nozzle rows;
accepting a result of checking the check patterns from a user; and
solving abnormality in accordance with the result of the checking.
